(19) United States
(12) Patent Application Publication
(10) Pub. No.: US 2017/0021208 A1
(43) Pub. Date: Jan. 26, 2017

(54) Covering for Protecting a Structure from Fire

(71) Applicant: David DOR-EL, Los Angeles, CA (US)

(72) Inventor: David DOR-EL, Los Angeles, CA (US)

(21) Appl. No.: 14/806,619

(22) Filed: Jul. 22, 2015

(51) Int. Cl. A62C 2/06; A62C 8/06; D04H 13/00; D03D 1/00; D04B 21/14

(52) U.S. Cl. CPC A62C 2/06; D03D 1/0035; D04B 21/14; D04H 13/001; A62C 8/06

(57) ABSTRACT

A fire protection device for use in isolating a building structure having several sides from an external fire includes a plurality of folded fire-resistant protective covers and a releasing mechanism. Each protective cover has dimensions large enough to cover one of the several sides of the building structure. The protective covers are composed of knit, woven or nonwoven textiles composed of flame resistant fibers including cotton, polyester, polyamide, viscose, themoset fibers, inorganic fibers and carbon fibers with a fabric areal weight between 20 grams per square meter to 300 grams per square meter. The textiles are impregnated with a fire resistant material which absorbs heat, such as aluminum trihydrate (ATH) or other hydrated metal salts, borates, silicates, phosphates, bromides and chlorides, moisture absorbing polymers such as poly-acrylates and starch derivatives so that the amount of impregnated material is less than 50% of the fabric weight. The releasing mechanism releases each protective cover.

### BACKGROUND OF THE INVENTION

Field of the Invention

The invention relates to an apparatus for protecting house or building, especially protecting residential house from a fire in neighborhood or area close by.

Description of the Prior Art

U.S. Patent Publication No. 2015/0176160 teaches a woven or knitted fabric which is formed of core spun yarns each including a core draw textured yarn (DTY) consisting of a core material of polyethylene terephthalate (PET) and a wrapper of cotton staple fibers, polyester staple fibers, rayon staple fibers, modal staple fibers, fire retardant staple fibers or a blend thereof. The fabric may be produced by ring spun, open-end or vortex. Regular yarns are mixed in the fabric. The woven and knitted fabrics have good tensile and tear strength properties, good abrasion resistance properties and natural and permanent wrinkle resistance properties. Core spun yarns is used to produce the woven and knitted fabrics with these properties. In order to increase tensile and tear strength, heavier fabrics with thicker and heavier yarns are usually utilized. These fabrics are thicker and heavier to meet the strength requirements. As a result, these fabrics tend to cause much discomfort to the wearer of the apparel, particularly in summer months. The wrinkle resistant properties of a fabric are normally achieved with the application of resins containing, among other chemicals, formaldehyde and then curing by heat. The rating of wrinkle resistance will deteriorate as the apparel is repeatedly laundered. Formaldehyde has been classified by the National Institutes of Health as being a carcinogen.

In order to increase abrasion resistance, heavier fabrics with thicker and heavier yarns are also utilized. These fabrics are thicker and heavier to meet the requirements. These fabrics tend to cause much discomfort to the wearer of the apparel, particularly in the summer months. The cost of these thicker and heavier fabrics is necessarily increased due to the use of more materials.

U.S. Patent Publication No. 2015/0159304 teaches flame and heat resistant yarns which include poly-acrylate fibers and flame retardant textile materials that are formed from such yarns. The flame and heat resistant yarns include a series of poly-acrylate fibers blended with a series of companion fibers, which can include other flame resistant fibers. The poly-acrylate fibers provide enhanced char strength to the yarns, while the companion fibers can be selected to provide increased tensile strength and other desired properties to the flame and heat resistant yarns. The flame and heat resistant yarns can be used to form fabrics or textile materials for use in a variety of applications, which fabrics exhibit a reduced fabric char length when subject to vertical flammability testing, and meet flammability requirements for any or all of National Fire Protection Association Standards NFPA 1971, NFPA 1975, NFPA 2112, NFPA 1951, NFPA 1977, and/or NFPA 70E; or which further meet or exceed the flame resistance requirements achieving an SFI Foundation performance rating of 3.2N1 to SFI 3.2A/40, and/or Code of Federal Regulations 16 CFR 1633. These yarns have flame retardant and heat resistant properties and as do the resultant fabrics formed there-from. The formation of flame retardant and heat resistant yarns incorporates poly-acrylate fibers. The formation of fabrics utilizes such yarns which meet or exceed the vertical flammability and thermal stability requirements of one or more fabric materials specified in National Fire Protection Association Standards NFPA 1971, NFPA 1975, NFPA 2112, NFPA 1951, NFPA 1977, and/or NFPA 70E, or which further meet or exceed the flame resistance requirements achieving an SFI Foundation performance rating of 3.2N1 to SFI 3.2N40, and/or Code of Federal Regulations 16 CFR 1633. Protective garments formed from fire retardant and/or heat resistant fabrics have long been in use for protecting workers in a variety of occupations. Firefighters, military and emergency personnel, and workers in fields such as auto racing, chemical/petroleum drilling and refining, steel making and other occupations where workers are at a high risk of exposure to fire, flame, and excessively high temperatures, generally are required to wear fire or flame resistant protective garments. ASTM Standard D6413 provides the standard practice and test protocol for vertical flammability resistance of fabrics. In this test, a fabric specimen is held in a vertical orientation, with its lower edge being exposed to a flame. In order to meet the requirements of the NFPA 1975 standard, the fabric specimen tested must exhibit a char length of less than or equal to six inches after exposure to a flame for twelve seconds, while under the NFPA 2112 standard, the fabric must exhibit a char length of less than or equal to four inches after a twelve second flame exposure. As noted above, it is important that a protective garment provide thermal insulation to the user and not rupture during flame contact. These properties are measured using the Thermal Protective Performance (TPP) test ISO 17492 set forth in Section 8.10 of NFPA 1971 Standard. The test exposes a horizontal fabric or layers of fabrics to a combined radiant/convective thermal flux of 2.0 cal/cm.sup.2 sec. The heat transfer through the system is measured using a backside copper calorimeter. As measured by the calorimeter, the timed rate of rise in temperature is compared to the time needed before the energy causes a second-degree human skin burn. Fabrics that break open during testing quickly reach the energy necessary for burn injury. The test method assigns fabrics a “TPP Rating,” defined as the time in seconds to reach a second degree skin burn multiplied by the heat flux (typically 2.0 cal/cm.sup.2 sec). The SFI Foundation sets its ratings for heat and/or flame resistant protective garments based upon the TPP Rating of the fabric materials from which the garments are constructed. An SFI suit with a 3.2N40 rating has a measured TPP value of 40 that predicts 20 seconds of protection before a second degree burn injury is reached. Flame resistance is also required for some non-apparel uses such as carpets, wall coverings, awnings, curtains, furniture and mattress fire blocking, and aircraft, trains, ships, buses, and automobiles. Fabric fire barriers for mattresses and furniture must pass flame resistance tests promulgated in the Code of Federal Regulations (16 CFR 1633).

U.S. Pat. No. 6,810,626 teaches fire protection devices which isolate building structures from an external fire and include a rolled fire-resistant protective cover having dimensions large enough to cover the building structure. The protective cover is then stored in a storage bag storing the protective cover and being disposed on a inclined top surface of the building structure. The device includes mechanism for releasing the rolled protective cover from the storage bag so that, upon release from the storage bag, the protective cover can roll down the inclined top surface by gravity.

Every year, a great number of people lose their valuable properties due to uncontrolled external fires, such as forest fires and wind-driven fires. Since these external fires are spreading very rapidly, it becomes extremely difficult for firefighters to control or contain them. Because of such rapid movements of these fires, homeowners in the midst of these fires are not given enough time to relocate their valuable belongings to a safe place or to take sufficient measures to protect their homes. They have to evacuate out of the area in a hurry, abandoning their valuable properties behind them. In order to protect building structures, including homes, from these uncontrolled external fires, there have been numerous attempts to develop fire protection devices that can isolate the building structures from these external fires. Various systems enclose the building structures from surrounding external fires by placing fire resistant materials over building structures have been proposed and utilized. These devices and methods generally involve impractical, complicated deployment mechanisms and/or require external power sources for deployment that are often unavailable. A barrier system for protection and resistance from externally started fires, forest fires and other fires that effect and start a structure burning from the outside inward. The barrier system comprising a specifically designed track system mounted onto the top of the structure, utilizing fire protective material hanging down the sides of the structure to create a fire resistant enclosure. The barrier system is designed to be assembled and set-up in advance on the structure in preparation of a fire. The barrier system design allows for ease and quickness with installation. Pre-installation of the barrier system on a roof of a structure that is being fire protected is provided by sectional pieces that are delivered to the structure and then installed in advance. The barrier system sectional pieces are designed to be different lengths and are adapted to the unique dimensions of the structure.

When one lives in Southern California and sees all the houses burning down it is easy to believe that a personally controlled system needs to be developed to reduce loss of home and private property and assist in control of insurance rates by offering lower risk to a structure owner in high fire areas.

U.S. Pat. No. 7,670,663 teaches a flame-resistant closure which includes at least one closing part having at least one two-dimensional backing fabric of warp threads and weft threads and having functional threads on the right side of the backing fabric. The functional threads at least partially extend through the backing fabric and form the closing elements. The backing fabric is of the non-flame-resistant type. At least some sections of the backing fabric reverse side include a substrate layer with a substantially inflammable medium and/or with an active extinguishing medium. This closure meets even high demands on inflammability. The flame-resistant closure in the manner of a fastening system includes a two-dimensional hook and loop closure part. The closure elements corresponding to one another can be caused to detachably engage. Fastening systems such as these have also become known under the trademark name Velcro or Velcro hook and loop closures. Woven hook and loop closure parts, whose warp, weft, and functional threads may be formed of textile fibers. Plastic or metal fibers are also readily available on the market in a host of embodiments. The functional threads in the backing fabric of warp and weft threads form loop-shaped interlocking elements, provided they are formed from multifilament threads. If the functional threads are formed from monofilament fibers, these closed loops are cut apart or thermally separated from one another to form closure hooks which can be caused to engage the correspondingly made fleece loop material of the other closure part of the fastening system. Closures such as these are characterized by recurring potential opening and closing processes. Fastening systems such as these are increasingly being used in transportation and aircraft engineering for attachment of wall panels to the carrier structure of a railway car or for attaching seat covering materials to aircraft passenger seats or the like. Especially in the area of aeronautic engineering increased demands are imposed at present on these fastening systems for low flammability. These demands are much stricter than earlier specifications in the form of EADS Specification FAR25.853(b). To satisfy that regulation EP-A-1 275 381 proposes coating a hook and loop closure part having closure elements with a flame retardant medium on the surface side and/or incorporating the pertinent flame-retardant medium into the closure itself. As the coating method an immersion process is suggested, with the flame-retardant media substances and substance groups being such as phosphorus, graphite, nitrogen and antimony compounds and aluminum derivatives and hydrates.

Organic phosphorus substances are used. For better joining of the flame-retardant medium to the closure material, the use of a binder in the form of vinyl acetate is proposed. Although the known closure on its top can be completely surrounded by the flame-retardant medium, or at least is formed partially of the flame-retardant medium itself, these measures are not currently adequate to meet the more stringent flame protection guidelines. EP-B-0 883 354 discloses a flame-retardant fastening element which, as part of a fastening system for detachable engagement, is matched to a second fastening element having a substrate layer of a flame-retardant polymer material into which U-shaped clamps are placed. The legs of the clamps form stem sections that on their free end project from the substrate layer each form a closure head. The closure elements formed in this way as closure mushrooms are securely anchored in the substrate layer on the base side by the clamp crosspiece. For attaching the fastening element to outside parts such as vehicle components or the like, a non-flame-retardant, pressure-sensitive cement is used and applied to a support surface facing away from the top of the substrate layer with the projecting fastening heads as part of the fastening element. In the known solution the non-flame-retardant, pressure-sensitive cement is a foam layer of a pressure-sensitive acrylic foam cement. Cements with this structure are detailed in WO-A-2005/017060. This solution forms a flame-retardant closure with very good action, but can be expensive in implementation, especially with respect to placing the U-shaped fastening elements in the substrate layer. In addition to using conventional plastic materials as cited above in the form of polyethylene, polyamide or the like for the closure material, EP-B-0 198 182 discloses the use of carbon fiber materials for implementation of a flame-retardant closure. In this known solution, with the formation of a flame-retardant closure both the loops and the backing material of the loop part as the backing-fabric from which the loops project are formed of carbon fibers. The hooks of the hook part itself should be formed from wire. Although in the known solution both the loop part and also the hook part have a textile character so that they can be processed like conventional textile hook and loop closures, in particular sewn on, their flame resistance far exceeds that of textile hook and loop closures of the conventional type, specifically 1,000.degree. C. The use of carbon fiber materials has, however, proven very costly, since carbon material is only available to a limited degree, at least for the present.

U.S. Patent Publication No. 2014/0031479 teaches a composite which includes a flame retardant, such as ATH and an expandable graphite. Alumina Trihydrate (ATH) is frequently added to polymer compositions to impart flame retardant properties. For many polymer compositions and applications, relatively high loading levels of ATH are necessary to impart the desired level of flame retardance to the material. Such high loading levels can make the processing and molding of loaded polymer compositions difficult, and can result in degraded physical properties of the materials. There is a need to address the aforementioned problems and other shortcomings associated with traditional ATH loaded polymer compositions. These needs and other needs are satisfied by the compositions and methods of the present disclosure.

U.S. Pat. No. 8,793,814 teaches fire resistant garments which are made from a fabric containing a fiber blend. The fiber blend contains meta-aramid fibers, fire resistant cellulose fibers, non-aromatic polyamide fibers, and optionally para-aramid fibers. A relatively lightweight fabric is produced that has been treated with a flame resistant polymer composition. The treated fabric is particularly well suited for producing jackets and trousers that are not only flame resistant, but also offer wind resistance and water resistance. Military personnel are issued and wear many different types of clothing items depending upon the actions they are performing, the climate they are working in, and based on various other factors. Such clothing items can include, for instance, pants, shirts, coats, hats, jackets, and the like. The clothing items are intended not only to keep the wearer warm and sheltered from the elements but to also provide protection, especially in combat areas. In the relatively recent past, the United States military has designed a garment or clothing system that includes multiple articles of clothing and garments. In one embodiment known as the extended cold weather clothing system (abbreviated ECWCS), the garment system includes seven separate layers or “levels” of clothing, wherein each layer and garment is configured to function alone or to be used in conjunction with the other articles of clothing in the system. The clothing system as described above is intended to be used in a broad climate range from very cold temperatures down to −40.degree. F. to higher temperatures of about 60.degree. F. The clothing system is designed such that the wearer can selectively pick and choose which clothing items to don depending upon the environmental conditions.

The extended cold weather clothing system generally includes the following layers or levels: Level 1: Light-weight undershirt and long underwear Level 2: Mid-weight shirt and heavier long underwear Level 3: High-loft fleece jacket Level 4: Wind jacket designed for wear under body armor Level 5: Soft shell jacket and trousers providing wind resistance and water resistance Level 6: Extreme wet/cold weather jacket and trousers having waterproof shell layer Level 7: Extreme cold weather parka and trousers

In the past, in order to produce fabrics having fire resistant properties, the fabrics were typically made from inherently flame resistant fibers. Such fibers, for instance, may comprise aramid fibers such as meta-aramid fibers or para-aramid fibers. Such fibers, for instance, are typically sold under the trade names NOMEX or KEVLAR or TVVARON. The use of inherently flame resistant fibers to produce garments, such as those worn by military personnel, are disclosed in U.S. Pat. No. 4,759,770, U.S. Pat. No. 5,215,545, U.S. Pat. No. 6,818,024, U.S. Pat. No. 7,156,883, U.S. Pat. No. 4,981,488 and U.S. Pat. No. 6,867,154. All of these patents are incorporated herein by reference.

U.S. Pat. No. 7,504,449 teaches formulations which include penta-bromobenzylbromide (PBBBr) and a carrier, for use as a flame retardant for application on a substrate, and processes for their preparation, articles-of-manufacture having these formulations applied thereon, and the use of PBBBr as a flame retardant for application on a substrate. These formulations are particularly effective as flame retardants for textiles, and are characterized by a low add-on and a high washing fastness. Textiles are an essential part of everyday life and are found in draperies, cloths, furniture and vehicle upholsteries, toys, packaging material and many more applications. Consequently, textile flammability is a serious industrial concern. The flammability of fabrics is typically determined by the nature of the fiber comprising the fabric. Some synthetic fibers, such as melamine, poly-aramides, carbonized acrylic, and glass, are inherently flame resistant, whereby others, such as cotton, polyester and linen, can readily ignite. The degree of flammability varies according to the fiber type and characteristics. A textile made of a blend of fibers usually burns faster and to higher temperatures compared with each fiber type alone. Fabric flammability also depends on the fabric thickness and/or looseness. The term “fiber” as defined hereinafter refers to a natural or synthetic filament capable of being spun into a yarn or made into a fabric. The terms “fabric”, “textile” and “textile fabric” are used herein interchangeably to describe a sheet structure made from fibers. Several approaches have been proposed heretofore for minimizing the fire hazard of flammable textiles. One approach involves fiber copolymerization with several fiber monomers being mixed and copolymerized, thus improving the properties of a certain fiber (e.g., a flammable fiber) through the enhanced properties of another fiber (e.g., a fire resistant fiber). This technique is limited by the number of existing fibers and their properties, and cannot be tailor-made for any substrate or requirements. Fiber types and fiber polymerization types are not necessarily compatible, thus further limiting the applicability of this technique. An additional disadvantage of this approach is the high cost of the fire resistant fibers.

Another approach involves the introduction of flame retardants (FR) in or on the fabric, using one of two methodologies is chemical post treatment with the fabric being treated with flame retardant chemicals after it has been produced, either by coating the fabric, or by the introduction of the FR into the fabric during the final dyeing process. The flame retardant can be applied to the back of the fabric (termed “back-coating”) or to its front (termed “front-coating”), depending on the specific fabric application. For draperies, furniture upholstering garments and linen, where the aesthetic appearance of the front side of the fabric is most important, back-coating is desired. A disadvantage of this methodology is the common need to apply the protective coating in large amounts (commonly termed “high add-on”) in order to obtain the required flame-resistant characteristics. Often, such high add-on adversely affects otherwise desirable aesthetical and textural properties of the fabric. Upon application of a FR, fabrics may become stiff and harsh and may have duller shades and poor tear strength and abrasion properties. Fiber-additive matrix (also termed “compounding”) with the FR being linked to the fiber during the melt spinning process, such that a fiber-additive molten plastic matrix is formed. This methodology has many drawbacks: degradation of the FR agent due to the high extrusion temperatures, reaction of the FR agent with the extruded fiber and subsequent modification of the fiber properties, such as fiber dyeability, fiber processability or other physical properties of the fiber and reaction of the FR agent with the various polymeric additives, such as dyes or catalysts. Another classification of FRs is according to the type of bonding between the FR and the fiber: a flame retardant is termed “additive” when it is mixed into, but not chemically reacted or bound to the fiber material. “Additive” FRs often easily migrate into the environment. A flame retardant is termed “reactive” when it is chemically inserted into the structure of the fiber material. “Reactive” FRs are bound to the fabric and hence do not easily migrate from the product into the environment and furthermore, typically do not degrade the physical properties of the fiber. Another serious problem in designing flame retardant fabrics, is fabric smoldering, which is particularly critical in fabrics that contain a high ratio of cellulose such as cotton, viscose, linen or other vegetable fibers. While some textiles may be resistant to open flame burning, the smoldering (also termed “after flame”), which may persist after the open flame has been extinguished, can eventually lead to complete digestion of the fabric, “Toxicological Risks of Selected Flame-Retardant Chemicals-2000”, Donald E. Gardner (Chair), Subcommittee on Flame-Retardant Chemicals, Committee on Toxicology, Board on Environmental Studies and Toxicology, National Research Council). Obviously, this leads to failure in many standard flammability tests, U.S. Pat. No. 3,955,032 and U.S. Pat. No. 4,600,606; and V. Mischutin, “Nontoxic Flame Retardant for Textiles” in J. Coated Fabrics, Vol. 7, 1978, pp. 308-318). Although one solution to this problem is coating the textile fabric with an impermeable material, obviously the feel of such a product is greatly damaged. In order to overcome the smoldering problem in textiles, the addition of a smoldering suppressant, which is also referred to herein, interchangeably, as a smoldering suppressing agent, is frequently required, in addition to the flame retardant agent. Selecting the suitable flame retardant and/or smoldering suppressant, and the suitable methodology for applying it to the fabric largely depends on the substrate which has to be protected: the protection of a garment, or the protection of an electrical appliance will inherently pose different requirements and restrictions of the flame retardant used. When used in textiles, an applied flame retardant has to be: (a) compatible with the fabric, (b) non-damaging to the aesthetical and textural properties of the fabric, (c) transparent, (d) light stable, (e) resistant to extensive washing and cleaning, (f) environmentally and physiologically safe, (g) of low toxic gas emittance, and (h) inexpensive. Above all, a flame retardant should pass the standard flammability tests in the field. Properties of the FR such as stability to UV light, heat, water, detergents and air-pollutants, as well as chemical stability, may be summed-up under the term “durability”. The most durable textiles are those which are inherently flame retardant, or which contain reactive (chemically bound) FRs. In the latter, the degree of durability depends on the strength of the bonds between the flame retardant formulation and the fiber. Additive (mixed) FRs, or chemically applied FRs which are water-soluble, are considered less durable. Furthermore, topically applied FR agents are generally not as durable as those which are incorporated into the fabric during the extrusion of the fiber. Thus, the topically applied FR agent may be washed off during the laundry cycle, and in these cases the expensive and burdensome dry cleaning of the textile has to be used. Currently, there are no clear-cut standards to define fabric durability, and it is commonly defined as a fabric meeting its performance standard after 5, 10 or 50 washes. Presently, there are four main families of flame-retardant chemicals: Inorganic flame retardants (such as aluminum oxide, magnesium hydroxide and ammonium polyphosphate); Halogenated flame retardants, primarily based on bromine and chlorine; Organophosphorus flame retardants, which are primarily phosphate esters; and Nitrogen-based organic flame retardants. Bromine-containing compounds have been long established as flame retardants. U.S. Pat. No. 3,955,032 and U.S. Pat. No. 4,600,606; and Mischutin [“Nontoxic Flame Retardant for Textiles” in J. Coated Fabrics, Vol. 7, 1978, pp. 308-318] teach flame retardation of textiles using formulations containing aromatic bromine compounds which are adhered to the substrates by mechanism of binders. The use of aromatic bromines as FRs for textiles, however, suffers major disadvantages including high bromine content demand, high dry add-on and/or binder demand, and a need to add compounds which enhance the flame retardancy (hereinafter termed a synergist). Application of such FRs on fabrics may result in streak marks on dark fabrics, excessive dripping during combustion of thermoplastic fibers, relatively high level of smoldering and a general instability of the flame retardant dispersion which may prevent a uniform application thereof on the fabric. Most of these drawbacks are inherent to the aromatic bromine compounds currently in use, “Toxicological Risks of Selected Flame-Retardant Chemicals-2000”, Donald E. Gardner (Chair) Subcommittee on Flame-Retardant Chemicals, Committee on Toxicology, Board on Environmental Studies and Toxicology, National Research Council]. Using existing bromine-containing FR formulations, a dry add-on of 60% or higher (compared to the dry fabric weight) is often required to obtain satisfactory flame retardation. This high add-on is due in part to the large amount of binder needed to affix the FR agents to the textile. The binder used in bromine-containing formulations typically constitutes about 50% by weight of the total FR formulation [Toxicological Risks of Selected Flame-Retardant Chemicals, page 506-507, V. Mischutin, Nontoxic Flame Retardant for Textiles, J. Coated Fabrics, Vol. 7, 1978, p. 315] and due to its substantial presence, contributes in itself to flammability and dripping, thus requiring even higher loading of bromine and creating an inefficient cycle. Furthermore, brominated FR formulations often suffer from storage instability. Ongoing research has therefore been conducted in order to obtain flame-retardants with improved performance, which are less detrimental to textile properties. Research has been particularly focused on providing an efficient FR which requires low binder content and is characterized by good dispersion properties. Recently, it has been shown that formulations combining phosphates and halogens display a synergism in flame retardation [E. S. Lee, “Possible Phosphorous Synergy in Polyester-Cotton Fabric Treated with Tetrabromobisphenol A and Diammonium Phosphate” in J. App. Pol. Sci., Vol. 84, 2002, pp. 172-177]. It has further been shown that phosphate and borate compounds are efficient solid phase flame retardants during combustion (G. Camino, M. P. Luda, “Fire Retardancy of Polymers: The use of Intumescents”, M. Le Bras, G. Camino, S. Bourbigot, R. Delobel, The Royal Society of Chemistry, 1888, p. 48, R. Dombrowski, Formulating Flame Retardant Coatings, Coated Fabrics Technology, Clemson University, 1998).

Compositions combine compounds containing aromatic bromine atoms and compounds containing aliphatic bromine atoms and are characterized by a broader temperature range for flame retardation, since the different bromine atoms react at different temperatures. This broader range creates more efficient flame retardation and hence, lower add-on of these compounds is required. A flame retardant compositions is described in WO 05/103361, which is incorporated by reference as if fully set forth herein, and includes a combination of tris(tribromophenyl)triazine and tetrabromobisphenyl A-bis(2,3-dibromopropyl ether). Combining the two bromine types within a single compound, has additional obvious advantages, such as reduced handling, enhanced compatibility, and less dispersion and application complexities. Penta-bromobenzylbromide (PBBBr) is an exemplary compound containing both an aromatic bromine and a benzylic bromine. WO 06/008738 teaches a process for the preparation of highly pure PBBBr and its use as a co-flame retardant in the preparation of FR expanded polystyrene foams (EPS).

WO 06/013554 teaches a styrenic polymer composition comprising a flame retardant, such as PBBBr and analogs thereof. These patent applications, however, fail to teach the use of PBBBr as a flame retardant for application on textiles, in which, as stated above, binders are often required so as to achieve the desirable results.

Japanese Patent No. 47032298 teaches the use of PBBBr as a flame retardant that is incorporated to the fabric by melt spinning with polyester fibers. In all of these examples, PBBBr was used as a flame retardant or as a co-flame retardant incorporated within the polymer in the melt. As detailed above, it is preferred to apply the flame retardant topically on the fabric, thereby avoiding the thermal degradation of the FR agent during melting, as well as preventing the adverse effect of the FR agent on the processability and on other properties of the fiber. It is difficult to topically apply an FR agent to textiles since topically applied FRs are easily washed off during the laundry cycle. It is therefore not surprising that PBBBr has never been prepared as a part of a coating or finishing formulation and has been only known to be directly incorporated into the polymeric fiber, where it was used either alone or in combination with other flame-retardants. There is a widely recognized need for, and it would be highly advantageous to have, novel flame retardant formulations devoid of the above limitations.

U.S. Pat. No. 8,822,355 teaches fire resistant composite materials which a substrate is selected from the group consisting of cotton, rayon, lyocell and blends thereof; and a coating consisting essentially of water, ammonium polyphosphate, urea formaldehyde binder material, prefabricated glass microcells, acrylic latex binder, ammonium lauryl sulfate surfactant, thickener material, a second surfactant, surfactant-generated microcells, a catalyst and starch. The binder materials bond the ammonium polyphosphate, prefabricated microcells, thickener material, surfactants, surfactant-generated microcells, catalyst and starch together and to the substrate such that the substrate is coated with the coating.

U.S. Pat. No. 5,091,243 teaches a fire barrier fabric which includes a substrate that is formed of corespun yarns and a coating carried by one surface of the substrate. Other fire resistant fabrics include Fenix (Milliken, LaGrange, Ga.) and fabrics made by Freudenberg (Lowell, Ma.), Ventex Inc. (Great Falls, Va.), BASF, Basofil Fiber Division (Enka, N.C.), Carpenter Co. (Richmond, Va.), Legget and Platt (Nashville, Tenn.), Chiquala Industries Products Group (Kingspoint, Tenn.), and Sandel (Amsterdam, N.Y.). DuPont also manufactures a fabric made from Kevlar™ thread. In addition, the mattress industry has attempted to manufacture mattresses by using Kevlar™ thread, glass thread, flame retardant polyurethane foams, flame retardant ticking, flame retardant cotton cushioning and flame retardant tape. However, use of these materials may add to the cost of mattresses and may result in a cost-prohibitive product. Additionally, some fire-resistant threads, such as glass threads, are difficult to work with and can break, adding to the time required for manufacturing the mattress, which also translates into added costs and can be irritating to the skin, eyes and respiratory system. Flame retardant tapes are also difficult to work with and increase production time. In addition, flame retardant tapes are only available in a limited number of colors and sizes. Flame retardant polyurethanes may release noxious gases when they smolder and ignite. The process for flame retarding ticking often compromises the desired characteristics of the ticking. For many years substrates such as fiberglass have been coated with various compositions to produce materials having utility in, among other applications, the building industry. U.S. Pat. No. 5,001,005 relates to structural laminates made with facing sheets. The laminates described in that patent include thermosetting plastic foam and have planar facing sheets comprising 60% to 90% by weight glass fibers (exclusive of glass micro-fibers), 10% to 40% by weight non-glass filler material and 1% to 30% by weight non-asphaltic binder material. The filler materials are indicated as being clay, mica, talc, limestone (calcium carbonate), gypsum (calcium sulfate), aluminum trihydrate (ATH), antimony trioxide, cellulose fibers, plastic polymer fibers or a combination of any two or more of those substances. The patent further notes that the filler materials are bonded to the glass fibers using binders such as urea-, phenol- or melamine-formaldehyde resins (UF, PF, and MF resins), or a modified acrylic or polyester resin. Ordinary polymer latexes used according to the disclosure are Styrene-Butadiene-Rubber (SBR), Ethylene-Vinyl-Chloride (EVCI), PolyVinylidene Chloride (PvdC), modified PolyVinyl Chloride (PVC), PolyVinyl Alcohol (PVOH), and PolyVinyl Acetate (PVA). The glass fibers, non-glass filler material and non-asphaltic binder are all mixed together to form the facer sheets. U.S. Pat. No. 4,745,032 discloses an acrylic coating which includes one acrylic underlying resin which includes fly ash and an overlying acrylic resin which differs from the underlying resin. U.S. Pat. No. 4,229,329 discloses a fire retardant coating composition comprising fly ash and vinyl acrylic polymer emulsion. The fly ash is 24 to 50% of the composition. The composition may also preferably contain one or more of a dispersant, a defoamer, a plasticizer, a thickener, a drying agent, a preservative, a fungicide and an ingredient to control the pH of the composition and thereby inhibit corrosion of any metal surface to which the composition is applied. U.S. Pat. No. 4,784,897 discloses a cover layer material on a basis of a matting or fabric that is especially for the production of gypsum boards and polyurethane hard foam boards. The cover layer material has a coating on one side which comprises 70% to 94% powdered inorganic material, such as calcium carbonate, and 6% to 30% binder. In addition, thickening agents and cross-linking agents are added and a high density matting is used. U.S. Pat. No. 4,495,238 discloses a fire resistant thermal insulating composite structure which includes a mixture of from about 50% to 94% by weight of inorganic microfibers, particularly glass, and about 50% to 6% by weight of heat resistant binding agent. U.S. Pat. No. 5,965,257 discloses a structural article having a coating that includes only two major constituents, while eliminating the need for viscosity modifiers, for stabilizers or for blowing.

U.S. Pat. No. 4,994,317 teaches a multilayered fire resistant material which includes a flame durable textile fabric substrate, a flexible silicone polymer layer, and a heat reflective paint. Clay may be added to the silicone layer to enhance flame resistance. U.S. Pat. No. 4,504,991 teaches a mattress comprising a composite material made of a layer of fire retardant material capable of providing a heat barrier bonded to a layer of high tensile strength material. The preferred heat barrier is neoprene and the preferred high tensile strength material is fiberglass. The fire retardant material chars, creating a heat shield that protects the inside of the mattress and that the high tensile strength material is required to maintain the structural integrity of the composite when it is exposed to fire to hold the mattress together and prevent the mattress from bursting open and exposing the flammable components of the mattress to the flames.

U.S. Pat. No. 8,987,149 teaches fire resistant composite materials and to fire resistant fabric materials which include a substrate selected from the group consisting of cotton, rayon, lyocell and blends thereof and a coating consisting essentially of water, ammonium polyphosphate, binder material, cross-linking material, thickener material and a catalyst. The binder material bonds the ammonium polyphosphate, cross-linking material, thickener material and catalyst together and to the substrate such that the substrate is coated with the coating. Various attempts have been made to produce fire resistant fabrics having characteristics that made them suitable for use in mattresses and in other applications, e.g., draperies and upholstery.

U.S. Pat. No. 5,540,980 teaches a fire resistant fabric which is formed from a corespun yarn that includes a high temperature resistant continuous filament fiberglass core and a low temperature resistant staple fiber sheath which surrounds the core. The fiberglass core includes about 20% to 40% of the total weight of the corespun yarn while the sheath includes about 80% to about 60% of the total weight of the corespun yarn. The corespun yarn can be woven or knit to form fabric with fire resistant characteristics. When exposed to a flame, the sheath chars and the fiberglass core serves as a fire barrier. In a preferred embodiment, the sheath is made from cotton. U.S. Pat. No. 5,091,243 discloses a fire barrier fabric which includes a substrate formed of corespun yarns and a coating carried by one surface of the substrate. Other fire resistant fabrics include Fenix™ (Milliken, LaGrange, Ga.) and fabrics made by Freudenberg (Lowell, Mass.), Ventex Inc. (Great Falls, Va.), BASF, Basofil Fiber Division (Enka, N.C.), Carpenter Co. (Richmond, Va.), Legget and Platt (Nashville, Tenn.), Chiquala Industries Products Group (Kingspoint, Tenn.), and Sandel (Amsterdam, N.Y.). DuPont also manufactures a fabric made from Kevlar thread. In addition, the mattress industry has attempted to manufacture mattresses by using Kevlar thread, glass thread, flame retardant polyurethane foams, flame retardant ticking, flame retardant cotton cushioning and flame retardant tape. Use of these materials may add to the cost of mattresses and may result in a cost-prohibitive product. Additionally, some fire-resistant threads, such as glass threads, are difficult to work with and can break, adding to the time required for manufacturing the mattress, which also translates into added costs and can be irritating to the skin, eyes and respiratory system. Flame retardant tapes are also difficult to work with and increase production time. In addition, flame retardant tapes are only available in a limited number of colors and sizes. Flame retardant polyurethanes may release noxious gases when they smolder and ignite. The process for flame retarding ticking often compromises the desired characteristics of the ticking (e.g. it may no longer be soft, drapable, pliable, flexible, etc). For many years substrates such as fiberglass have been coated with various compositions to produce materials having utility in, among other applications, the building industry.

U.S. Pat. No. 5,001,005 teaches structural laminates which are made with facing sheets and which include thermosetting plastic foam and have planar facing sheets including 60% to 90% by weight glass fibers (exclusive of glass micro-fibers), 10% to 40% by weight non-glass filler material and 1% to 30% by weight non-asphaltic binder material. The filler materials are indicated as being clay, mica, talc, limestone (calcium carbonate), gypsum (calcium sulfate), aluminum trihydrate (ATH), antimony trioxide, cellulose fibers, plastic polymer fibers or a combination of any two or more of those substances. The filler materials are bonded to the glass fibers using binders such as urea-, phenol- or melamine-formaldehyde resins (UF, PF, and MF resins), or a modified acrylic or polyester resin. Ordinary polymer latexes used according to the disclosure are Styrene-Butadiene-Rubber (SBR), Ethylene-Vinyl-Chloride (EVCI), PolyVinylidene Chloride (PvdC), modified PolyVinyl Chloride (PVC), PolyVinyl Alcohol (PVOH), and PolyVinyl Acetate (PVA). The glass fibers, non-glass filler material and non-asphaltic binder are all mixed together to form the facer sheets.

U.S. Pat. No. 4,745,032 teaches an acrylic coating which includes one acrylic underlying resin that includes fly ash and an overlying acrylic resin which differs from the underlying resin. U.S. Pat. No. 4,229,329 discloses a fire retardant coating composition that includes fly ash and vinyl acrylic polymer emulsion. The fly ash is 24 to 50% of the composition. The composition may also preferably contain one or more of a dispersant, a defoamer, a plasticizer, a thickener, a drying agent, a preservative, a fungicide and an ingredient to control the pH of the composition and thereby inhibit corrosion of any metal surface to which the composition is applied. U.S. Pat. No. 4,784,897 discloses a cover layer material on a basis of a matting or fabric which is especially useful for the production of gypsum boards and polyurethane hard foam boards which has a coating on one side which includes 70% to 94% powdered inorganic material, such as calcium carbonate, and 6% to 30% binder. In addition, thickening agents and cross-linking agents are added and high-density matting is used.

U.S. Pat. No. 4,495,238 discloses a fire resistant thermal insulating composite structure that includes a mixture of from about 50% to 94% by weight of inorganic microfibers, particularly glass, and about 50% to 6% by weight of heat resistant binding agent. U.S. Pat. No. 5,965,257 discloses a structural article having a coating which includes only two major constituents, while eliminating the need for viscosity modifiers, for stabilizers or for blowing and which is made by coating a substrate having an ionic charge with a coating having essentially the same ionic charge. The coating consists essentially of a filler material and a binder material. U.S. Pat. No. 4,745,032 discloses an acrylic coating comprised of one acrylic underlying resin which includes fly ash and an overlying acrylic resin which differs from the underlying resin.

U.S. Pat. No. 4,229,329 discloses a fire retardant coating composition which includes fly ash and vinyl acrylic polymer emulsion. The fly ash is 24 to 50% of the composition. The composition may also contain one or more of a dispersant, a defoamer, a plasticizer, a thickener, a drying agent, a preservative, a fungicide and an ingredient to control the pH of the composition and thereby inhibit corrosion of any metal surface to which the composition is applied. U.S. Pat. No. 4,495,238 discloses a fire resistant thermal insulating composite structure which includes a mixture of from about 50% to 94% by weight of inorganic microfibers, particularly glass, and about 50% to 6% by weight of heat resistant binding agent.

U.S. Pat. No. 5,965,257 teaches a structural article that has a coating that includes only two major constituents, while eliminating the need for viscosity modifiers, for stabilizers or for blowing. The coating consists essentially of a filler material and a binder material. U.S. Pat. No. 6,858,550 teaches a fire resistant fabric material that includes a substrate having an ionic charge coated with a coating having essentially the same ionic charge. The coating includes a filler component that includes clay and a binder component. The fire resistant fabric material produced has satisfactory flexibility, pliability and drapability characteristics. While this material is suitable as a fire resistant fabric material, it is desirable to provide a fire resistant material that would also have cushioning or “bounce-back” characteristics.

The applicants hereby incorporate the above-referenced patents into their specification.

### SUMMARY OF THE INVENTION

The invention is generally directed to a fire protection device for use in isolating a building structure having several sides from an external fire. The first protection device includes a plurality of folded fire-resistant protective covers and a releasing mechanism. Each protective cover has dimensions large enough to cover one of the several sides of the building structure. The releasing mechanism releases each protective cover.

In the first aspect of the invention each fire-resistant protective covers have dimensions large enough to cover one of the several sides of the building structure.

In the second aspect of the invention the fire-resistant protective covers are composed of knit, woven or nonwoven textiles composed of flame resistant fibers including cotton, polyester, polyamide, viscose, themoset fibers, inorganic fibers and carbon fibers with a fabric areal weight between 20 grams per square meter to 300 grams per square meter.

In a third aspect of the invention the textiles are impregnated with a fire resistant material which absorbs heat, such as aluminum trihydrate (ATH) or other hydrated metal salts, borates, silicates, phosphates, bromides and chlorides, moisture absorbing polymers such as poly-acrylates and starch derivatives so that the amount of impregnated material is less than 50% of the fabric weight.

In a fourth aspect of the invention a sensing system includes a plurality of sensors and a central processing unit which receives data of each of said sensors and transmits a signal to the releasing mechanism which releases the protective covers in response to the signal.

In a fifth aspect the fire protection device is used in isolating a vehicle, which may be either a truck or an airplane, from an external fire.

In a sixth aspect of the invention a firing mechanism is attached to a robotic unit. The firing mechanism is coupled to the folded fire-resistant protective covers and serially propels each folded fire-resistant protective cover.

In a seventh aspect of the invention the fire protection device for use in isolating a building structure includes a plurality of canister and an explosive device that is coupled to each canister.

The ninth aspect of the invention a sensing system has a plurality of sensors and a central processing unit. The central processing unit receives data of each sensor and transmits the signal to releasing mechanism.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is a schematic perspective view of an apparatus for protecting house or building from fire in accordance with U.S. Pat. No. 5,748,072.

FIG. 2 is a schematic front view of the apparatus for protecting house or building from fire.

FIG. 3 is an assembly drawing of “ESFPS” according to U.S. Pat. No. 7,395,869.

FIG. 4 is an assembly drawing of “ESFPS” according to U.S. Pat. No. 7,395,869

FIG. 5 is a detailed parts drawing of “ESFPS” according to U.S. Pat. No. 7,395,869.

FIG. 6 is a detailed parts drawing of “ESFPS” according to U.S. Pat. No. 7,395,869

FIG. 7 is a drawing of the magnetic/fabric connection of “ESFPS” according to U.S. Pat. No. 7,395,869

FIG. 8 is a perspective view of a building structure having a fire protection device installed on the roof, according to U.S. Pat. No. 6,810,626.

FIG. 9 is a plan view of a fire-resistant protective cover used for enveloping a building structure, according to U.S. Pat. No. 6,810,626.

FIG. 10 is a perspective view of the protective cover of FIG. 9 illustrating a state in which the protective cover is rolled in prior to placement in a storage bag, according to U.S. Pat. No. 6,810,626.

FIG. 11 is a cross-sectional view of a fire-resistant protective cover used for enveloping a building structure, according to U.S. Pat. No. 6,810,626.

FIG. 12 is a partial side view of a storage bag, according to U.S. Pat. No. 6,810,626.

FIG. 13 is a partial top view of a storage bag, according to U.S. Pat. No. 6,810,626.

FIG. 14 is a perspective view of the building structure with the protective cover being released from the storage bag, according to U.S. Pat. No. 6,810,626.

FIG. 15 is a top view of the building structure with the protective cover being released from the storage bag, according to U.S. Pat. No. 6,810,626.

FIG. 15 is a top view of the building structure with the protective cover being released from the storage bag, according to U.S. Pat. No. 6,810,626.

FIG. 16 is a top view of the building structure with the protective cover being released from the storage bag, according to U.S. Pat. No. 6,810,626.

FIG. 17 is a top view of the building structure with the protective cover being released from the storage bag, according to U.S. Pat. No. 6,810,626.

FIG. 18 is a general schematic overview of a system, according to U.S. Pat. No. 6,847,892.

FIG. 19 is a schematic of a Remote Localization and Sensing Device, according to U.S. Pat. No. 6,847,892.

FIG. 20 is a schematic of a Remote Localization and Sensing Device, according to U.S. Pat. No. 6,847,892.

FIG. 21 is a schematic of a Remote Localization and Sensing Device, according to U.S. Pat. No. 6,847,892.

FIG. 22 is a perspective view of a covering for protecting a building from fire according to U.S. Pat. No. ______ installed on a house.

FIG. 23 is a side elevational view of the covering of FIG. 22 installed on a house.

FIG. 24 is a schematic drawing of a fire protection device which is used in isolating a building structure having several sides from an external fire and which includes a plurality of folded fire-resistant protective covers each of which has dimensions large enough to cover one of the several sides of the building structure according to the present invention

FIG. 25 is a schematic drawing of the fire protection device of FIG. 24 which the folded fire-resistant protective covers have been released and unfolded

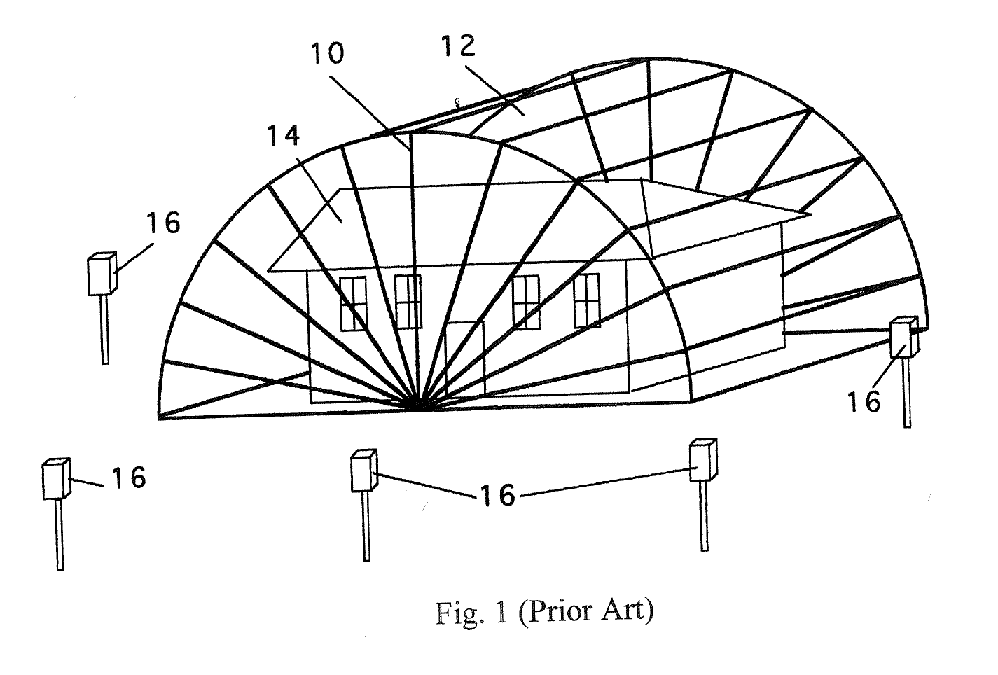

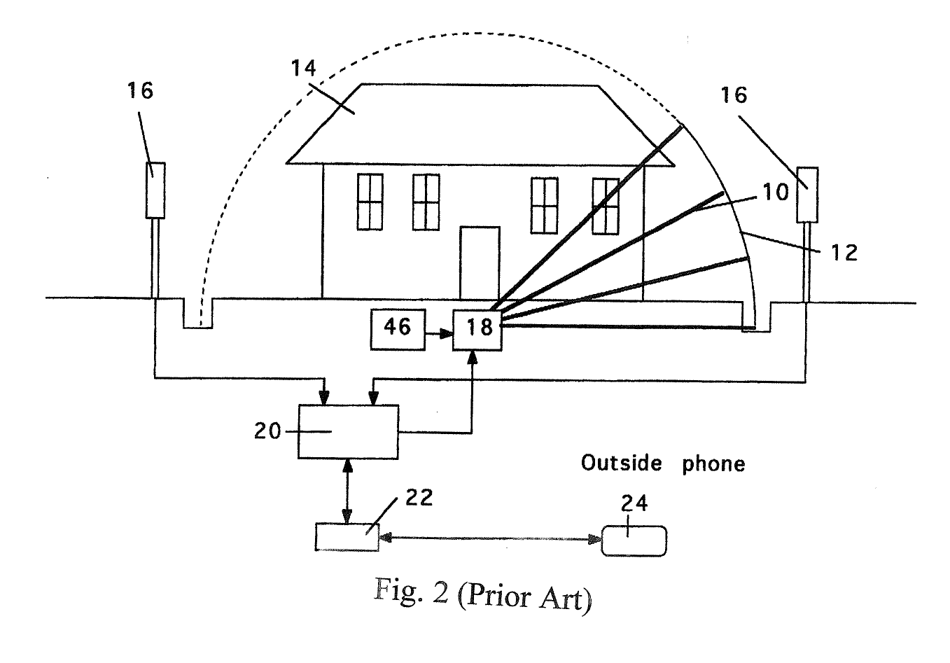

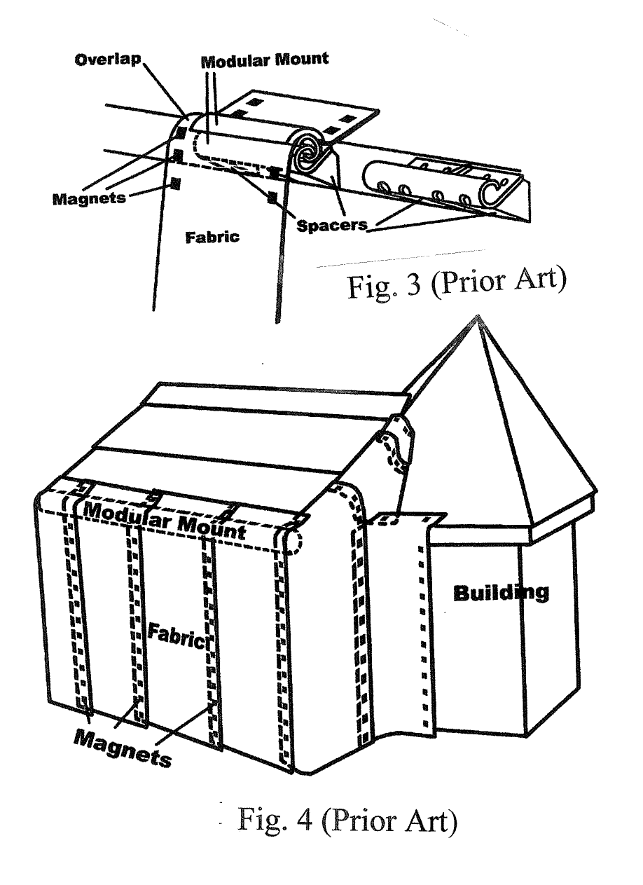

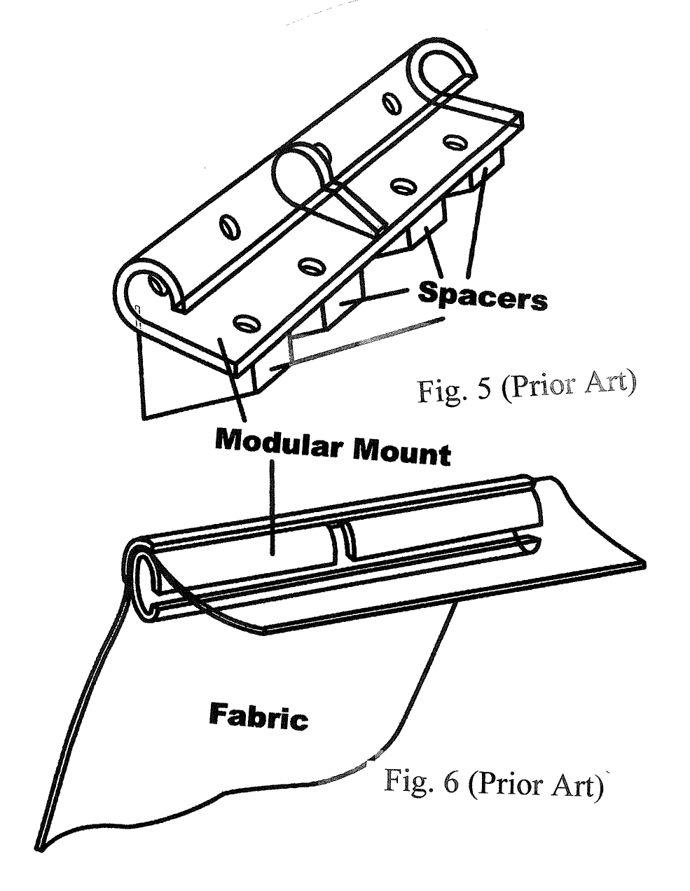

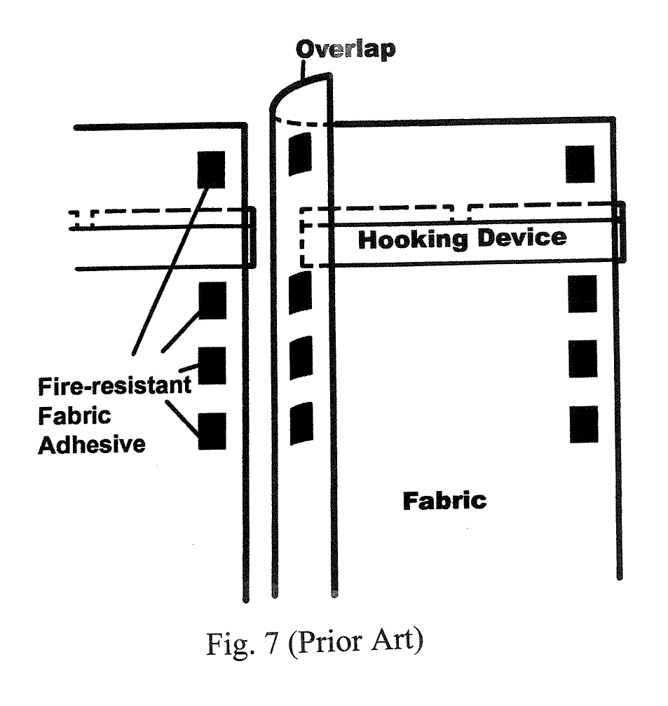

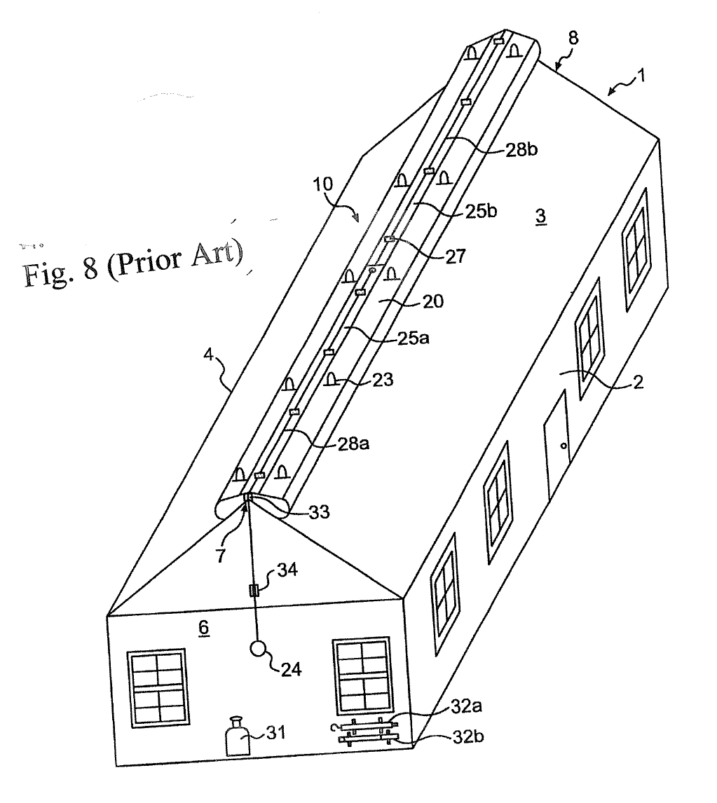

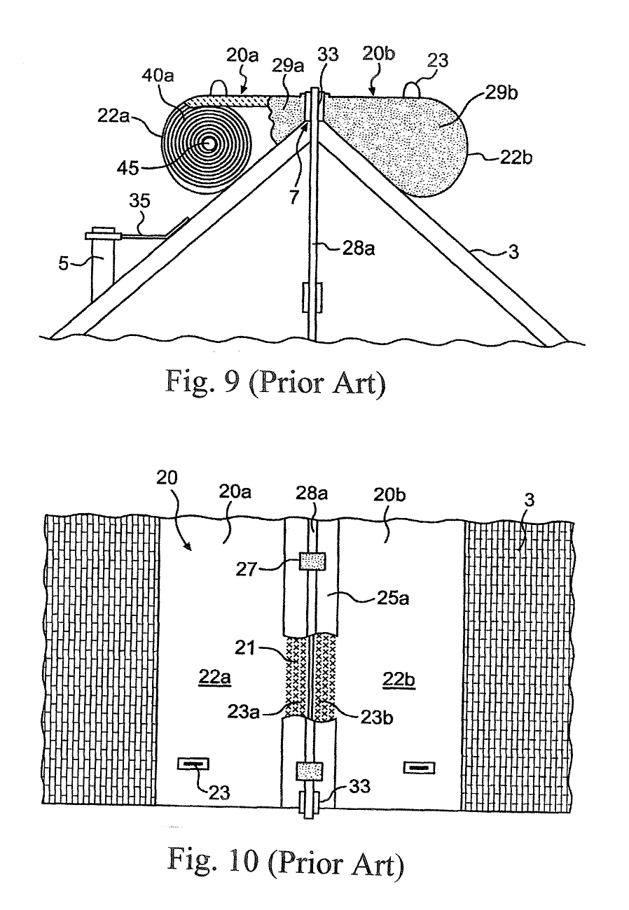

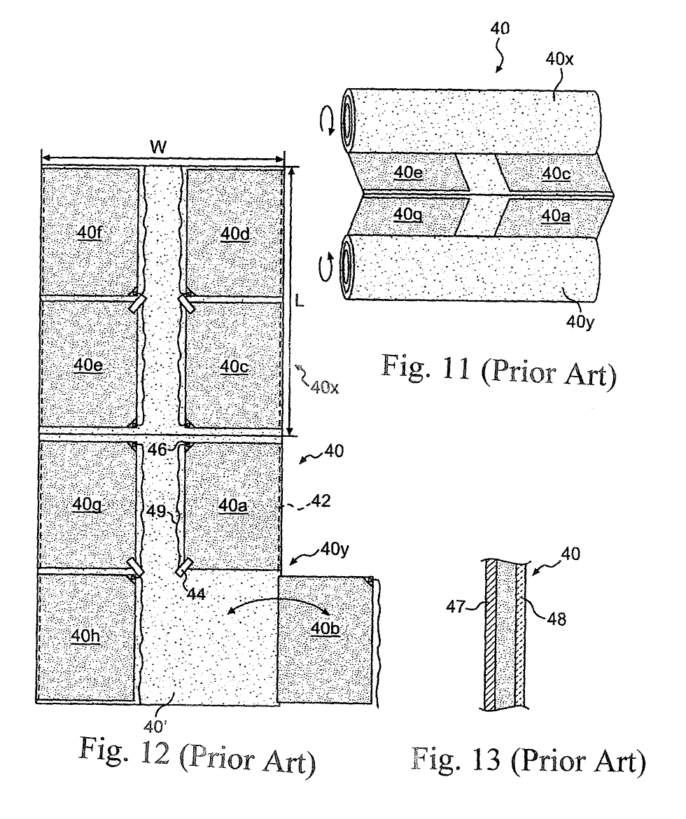

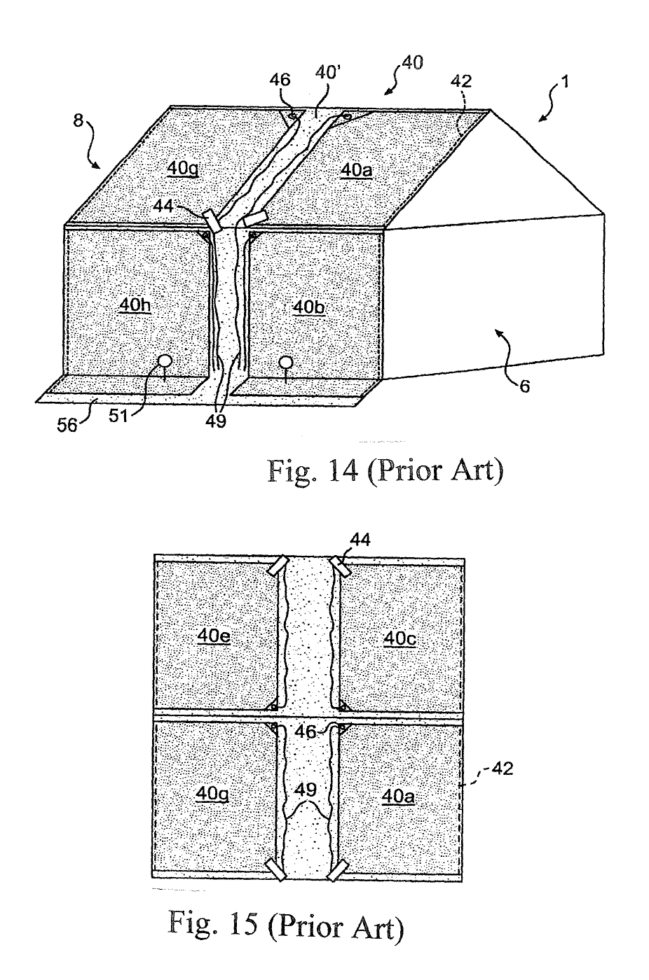

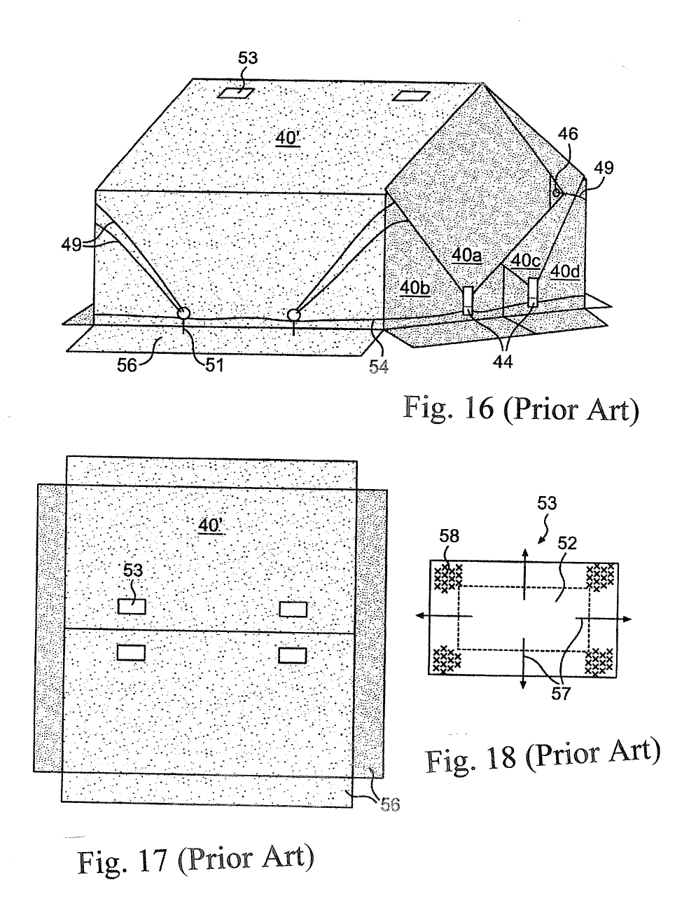

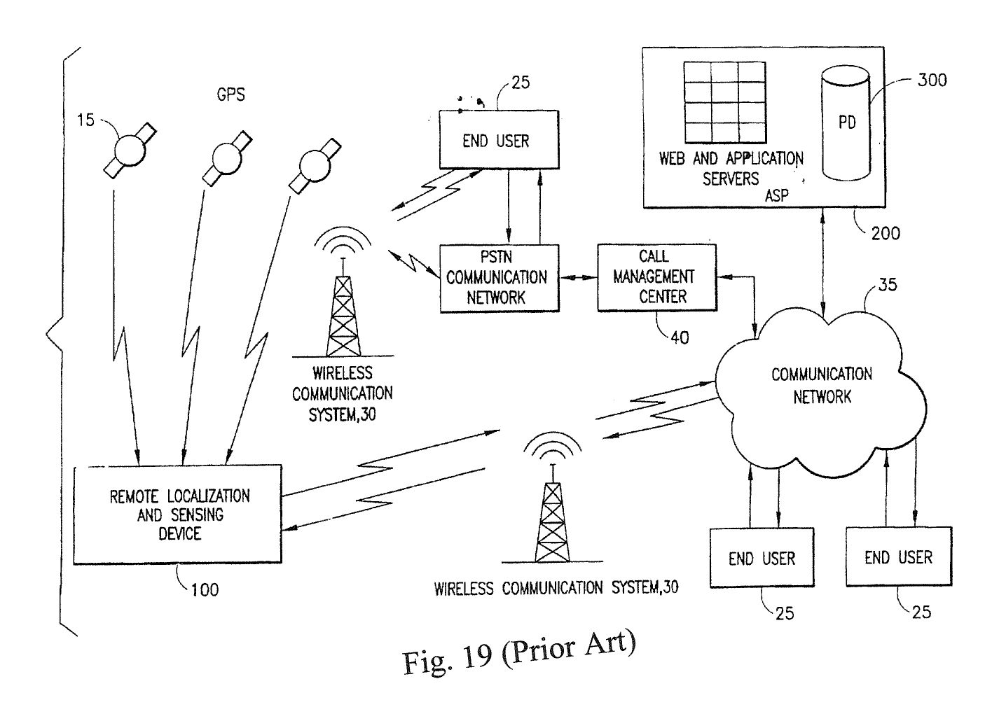

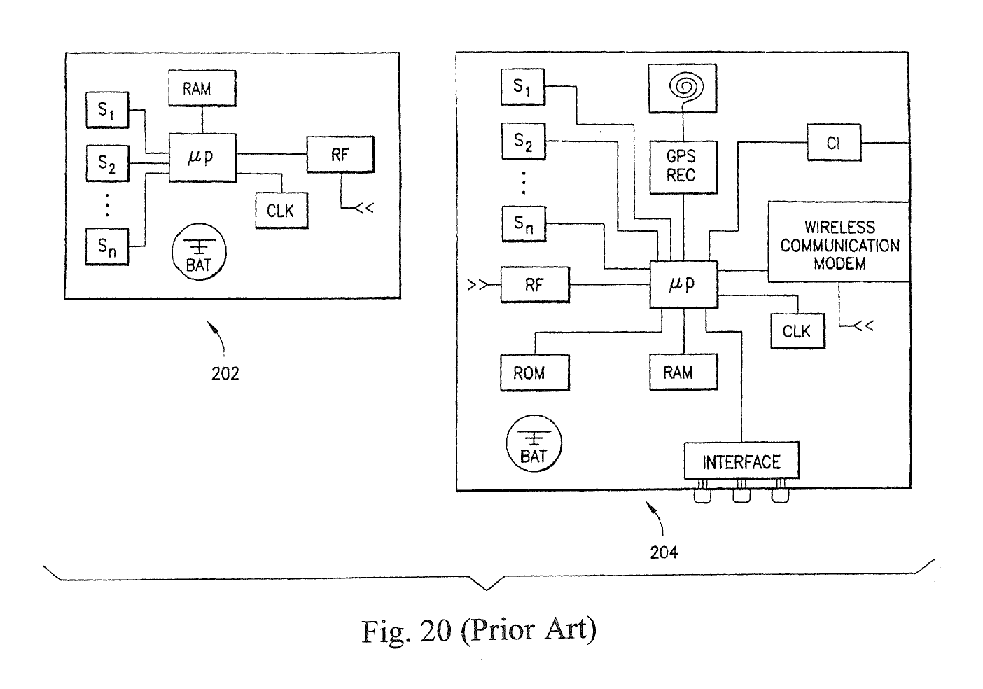

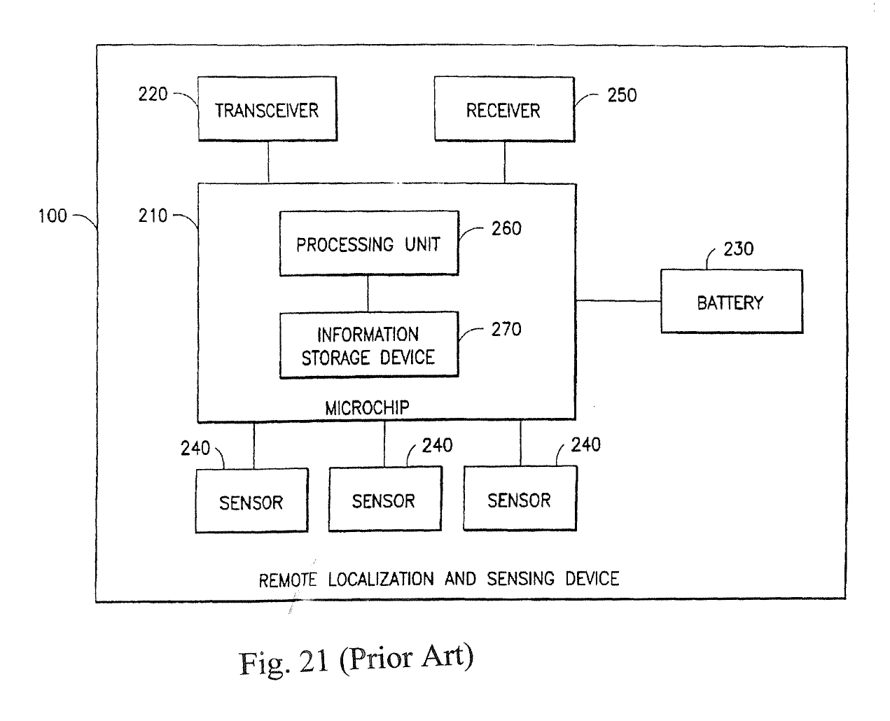

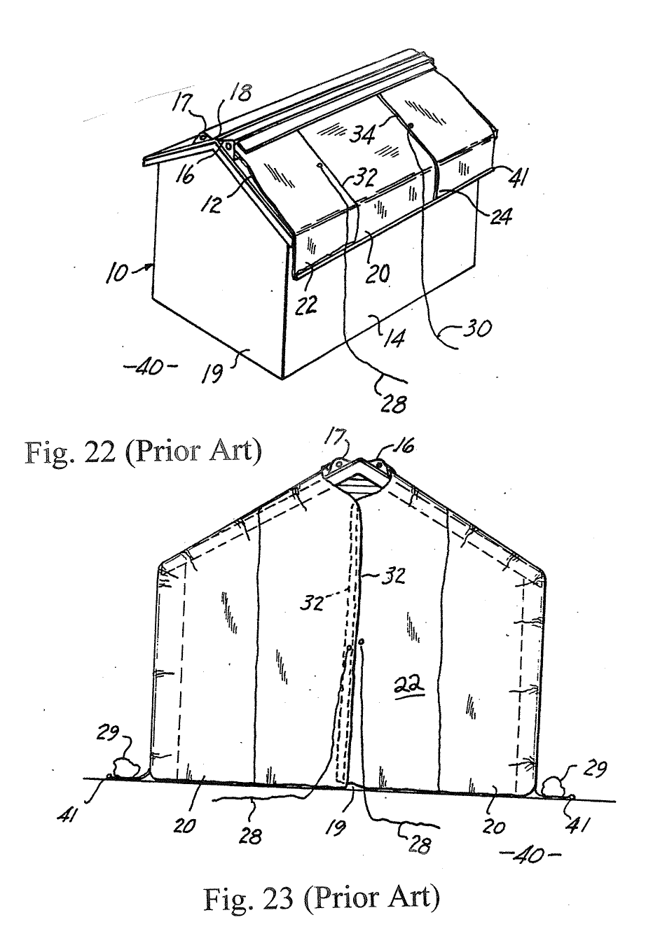

### DESCRIPTION OF THE PREFERRED EMBODIMENT

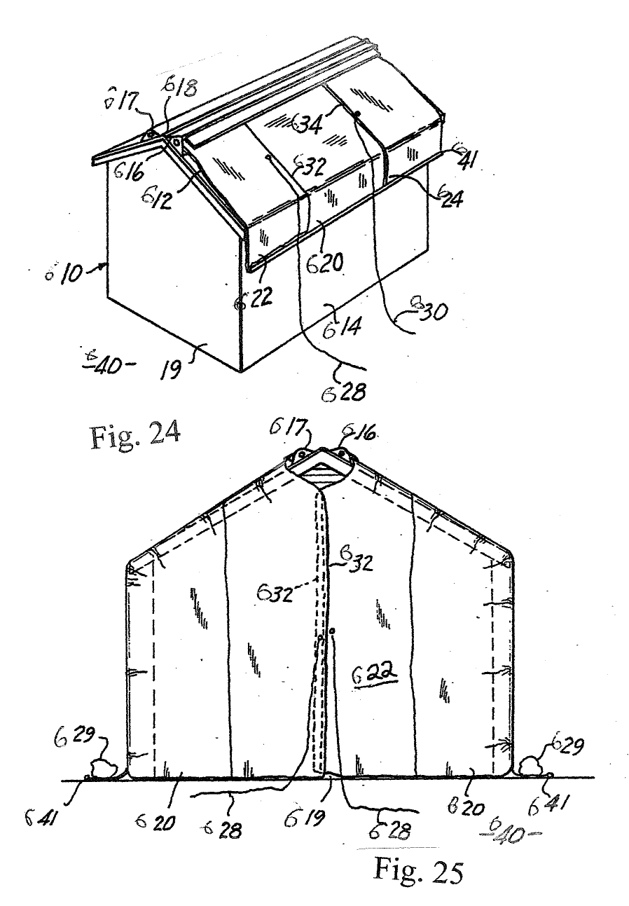

Referring to FIG. 24 in conjunction with FIG. 25 a fire protection device 610 involves placing a fire resistant sheet material over a building to prevent the building from burning down in a surrounding fire. There is nothing more important with these types of fire protection devices than being able to quickly deploy them before a fire starts on the building to be protected. Often there is little warning of an approaching fire, especially in urban areas where the threatening fire starts in the next-door neighbor's house at night. Also, wild fires overtake rural buildings with amazing speed. Without the ability to quickly and completely deploy the fire protective sheet material, the building will succumb to tire before the sheet material can be deployed. A building 611 has a pitched roof 612 and perpendicular walls 614 and 619. Housings 616 and 617 are adjacent and parallel to the ridge 618 of the roof 612. Each of the housings 616 and 617 contains a cylinder upon which the sheet material 620 is rolled in order to compact the sheet material 620 within each of the housings 616 and 617. The sheet material 620 is folded in at least one location to define folded portions 622 and 624 before the sheet material 20 is rolled over the cylinder within each of the housings 616 and 617. Deployment or the compacted sheet material 620 is accomplished by lines 628 and 630 which are connected to the edges 632 and 634 of the folded portions 622 and 624, respectively. The user pulls on lines 628 and 630 to cause the sheet material 620 to be removed from housing 616, deployed over the roof 612 in its folded over condition and pulled to the ground 640 where it will later be secured. Each sheet material 620 is deployed over the wall 619 as well as the wall 614 by pulling on lines 628 and fastening edges 632 where they intersect with Velcro or other suitable means of securing these edges together against the wind caused by a fire. The same procedure is accomplished for the other wall by pulling lines 630 and securing the edges 634 together with Velcro. The result is a very quickly and completely deployed fire resistant sheet material 620 which will substantially prevent the building 611 from burning. The sheet materials 620 may be secured to the ground 640 by placing rocks 629 over the material which overlays the ground 640. In addition, a bar 641 may be sewn in the leading edge of each sheet material 620 to better secure each sheet material to the ground 40 and to better deploy the sheet material 620 from either of its housings 616 or 617.

Still referring to FIG. 24 in conjunction with FIG. 25 the fire protection device 610 is used in isolating a building structure 611 having several sides from an external fire. The fire protection device 610 includes a plurality of folded fire-resistant protective covers 710 and releasing mechanism 720. Each fire-resistant protective cover 711 has dimensions large enough to cover one of the several sides of the building structure 611. The fire-resistant protective covers/textiles 711 are composed of knit, woven or nonwoven textiles composed of flame resistant fibers including cotton, polyester, polyamide, viscose, themoset fibers, inorganic fibers and carbon fibers with a fabric areal weight between 20 grams per square meter to 300 grams per square meter. The textiles 711 are impregnated with a fire resistant material which absorbs heat, such as aluminum trihydrate (ATH) or other hydrated metal salts, borates, silicates, phosphates, bromides and chlorides, moisture absorbing polymers such as poly-acrylates and starch derivatives so that the amount of impregnated material is in the range of 30% to 50% of the fabric weight. The releasing mechanism 720 releases each protective covers 711.

From the foregoing it can be seen that a covering for protecting a building from fire has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

What is claimed is:

1. A fire protection device for use in isolating a building structure having several sides from an external fire, the device comprising:
a. a plurality of folded fire-resistant protective covers each of which has dimensions large enough to cover one of the several sides of the building structure wherein said covers are composed of knit, woven or nonwoven textiles composed of flame resistant fibers including cotton, polyester, polyamide, viscose, themoset fibers, inorganic fibers and carbon fibers with a fabric areal weight between 20 grams per square meter to 300 grams per square meter and wherein said textiles are impregnated with a fire resistant material which absorbs heat, such as aluminum trihydrate (ATH) or other hydrated metal salts, borates, silicates, phosphates, bromides and chlorides, moisture absorbing polymers such as poly-acrylates and starch derivatives so that the amount of impregnated material is less than 50% of the fabric weight; and
b. a releasing mechanism wherein said releasing mechanism releases each of said protective covers.

2. A fire protection device according to claim 1 wherein the amount of impregnated material is less than 40% of fabric weight.

3. A fire protection device according to claim 1 wherein the amount of impregnated material is less than 30% of fabric weight.

4. A fire protection device according to claim 1 wherein said fire protection device includes a sensing system including a plurality of sensors and a central processing unit which receives data of each of said sensors and transmits a signal to said releasing mechanism which releases said covers in response to said signal.

5. A fire protection device for use in isolating a vehicle, which may be either a truck or an airplane, from an external fire, the device comprising:
a. a plurality of folded fire-resistant protective covers each of which has dimensions large enough to cover one of the several sides of the vehicle wherein said covers are composed of knit, woven or nonwoven textiles composed of flame resistant fibers including cotton, polyester, polyamide, viscose, themoset fibers, inorganic fibers and carbon fibers with a fabric areal weight between 20 grams per square meter to 300 grams per square meter and wherein said textiles are impregnated with a fire resistant material which absorbs heat, such as aluminum trihydrate (ATH) or other hydrated metal salts, borates, silicates, phosphates, bromides and chlorides, moisture absorbing polymers such as poly-acrylates and starch derivatives so that the amount of impregnated material is less than 50% of the fabric weight; and
b. a releasing mechanism wherein said releasing mechanism releases each of said protective covers.

6. A fire protection device for use in isolating a building structure having several sides from an external fire according to claim 1 wherein said firing mechanism is attached to a robotic unit.

7. A fire protection device for use in isolating a building structure having several sides from an external fire according to claim 4 wherein said firing mechanism includes a plurality of said folded fire-resistant protective covers and wherein said firing mechanism serially propels each of said folded fire-resistant protective covers.

8. A fire protection device for use in isolating a building structure having several sides from an external fire according to claim 4 wherein said firing mechanism is attached to a robotic unit.

9. A fire protection device for use in isolating a building structure from an external fire according to claim 1 wherein an explosive device is coupled to each of said canisters.

10. A fire protection device for use in isolating a vehicle structure from an external fire according to claim 5 wherein an explosive device is coupled to each of said canisters.
